(19) United States
(12) Patent Application Publication
(10) Pub. No.: US 2005/0075112 A1
(43) Pub. Date: Apr. 7, 2005

(54) Method and device for localising packet data service-capable radio stations in a communication system

(76) Inventors: Carsten Ball, Munchen (DE); Ralf Krannich, Heiligenhaus (DE); Christian Mucke, Petershausen (DE)

Correspondence Address: STAAS & HALSEY LLP, SUITE 700, 1201 NEW YORK AVENUE, N.W., WASHINGTON, DC, 20005, US

(21) Appl. No.: 10/467,412

(22) PCT Filed: Jan. 17, 2002
(86) PCT No.: PCT/EP02/00447

(30) Foreign Application Priority Data
Feb. 8, 2001 (EP) 01102979.0
Feb. 8, 2001 (DE) 101-05-678.8

(51) Int. Cl. H04K 1/00; H04B 1/69; H04B 1/707

(52) U.S. Cl. 455/456.1; 342/457; 375/132

(57) ABSTRACT

Mobile stations communicate with a network station in a radio cell of a network via at least one radio interface. Localization of the position of the stations is carried out by the network either periodically or according to demand. To enable fast provision of localized information, the actual locations and experienced radio conditions of the stations are stored by the network. The packet data service enabled stations can be used advantageously for other methods known for other purposes, e.g. for determining received field intensity or interference level, for carrying out cell change or for activating a polling request.

### CROSS REFERENCE TO RELATED APPLICATIONS

This application is based on and hereby claims priority to European Application No. 01102979.0 filed on Feb. 8, 2001 and German Application No. 10105678.8 filed on Feb. 8, 2001, the contents of which are hereby incorporated by reference.

### BACKGROUND OF THE INVENTION

1. Field of the Invention

The invention relates to a method for localizing packet service-capable radio stations in a communication system or a communication system with devices to execute such a method.

2. Description of the Related Art

In radio communication systems information, for example voice, picture information or other data is transmitted with the aid of electromagnetic waves via a radio interface between sending and receiving station (base station or mobile station). The electromagnetic waves are radiated here with the carrier frequencies which lie within the frequency band provided for the relevant system. For future mobile radio systems with CDMA or TD/CDMA transmission procedures (TD/CDMA: Time/Code Division Multiple Access) via the radio interface, for example the UMTS (Universal Mobile Telecommunication System) or other 3rd-generation systems, frequencies in the frequency band of around 2000 MHz are envisaged.

In existing mobile radio networks in accordance with the GSM Standard (GSM: Global System for Mobile Communications) with frequencies between 400 MHz and 2000 MHz these types of innovative data services such as GPRS (General Packet Radio System) as well as their expansions EDGE/EGPRS (Enhanced Data Rates for GSM Evolution/Enhanced GPRS) are currently being introduced. In these systems the transmission in the radio network is not connection-oriented nor is it circuit-switched but takes the form of packet data. This type of transmission typically makes better use of the given transmission resources in the mobile radio network by multiplexing.

In the TDMA procedure, such as for example with GSM or also TDD-UMTS (TDD: Time Division Duplex) for a TDMA component there is provision for subdividing a broadband carrier with for example a frequency range of 5 MHz for UTMS or a narrowband carrier with for example 200 KHz for GSM into a number of times slots of the same duration. With TDD-UMTS a part of the time slots in the downlink direction (DL) from the base station to the mobile station and a part of the time slots in the uplink direction (UL) from the mobile station to the base station will be used. With the GSM standard eight time slots are provided on two 200 KHz carrier frequencies separated by a duplex gap for the uplink connection and the downlink connection. For data transmission with the packet data services GPRS/EGPRS in accordance with the GSM standard each time slot is assigned a packet data traffic channel a (PDTCH). The packet data traffic channels are unidirectional. The data is either transmitted in the uplink direction (UL) for the packet data transmission from the mobile station to the base station or in the downlink direction and (DL) for packet data transmission from the base station and to the mobile station. In this case a packet data traffic channel can be assigned to a subscriber for a fixed channel allocation in accordance with the GSM 04.60 permanently for a specific time interval or with a dynamic channel allocation in accordance with GSM 4.60) to a number of subscribers simultaneously, i.e. a number of subscribers are supplied on this packet data traffic channel (multiplexing). This applies to the uplink and the downlink independently of each other.

With these systems it is necessary for a multiplicity of purposes to determine the current positions of the subscriber stations. Location services are known for efficient realization of localization which are also used for mobile stations for packet data-capable (GPRS, EDGE) mobile radio services in GSM mobile radio networks.

For circuit switched services the Standard already contains a large number of methods such as TA (timing advance). E-OTD (Enhanced Observed Time Difference), GPS (Global Positioning System), etc. With the TA method the SLMC (Serving Mobile Station Location Center) is polled for the current position of a specific mobile station. If the subscriber station is idle at this point it is addressed from the network or paging is undertaken after which the network assigns a channel to the mobile station. In the reserved or switched mode (dedicated mode) the mobile station is already active on a channel. The mobile station localization center responsible then requests from the base station the TA currently used in the base station system as well as optionally the last measurement report sent by the mobile station. After thus data has been forwarded to the mobile station localization center responsible the position of the mobile station is calculated in accordance with the known method and finally the position result is forwarded to the interrogating unit. There are also methods by which for example the subscriber station continually calculates its position independently and notifies the network on the basis of interrogations or procedures that determine a location by external hardware, e.g. what is known as a Location Measurement Unit (LMU).

The disadvantage of such methods is that the network of the mobile station must assign dedicated channels, for example to interrogate position-relevant measurement data, which in the final analysis is a disadvantage for the cell capacity. Furthermore only one subscriber station can ever be interrogated in turn before it can deliver the measurement data mobile station localization center responsible. Without a prior request the position of a mobile station is thus not known to the network with the existing LCS (Location Service) method.

With such location services methods known methods of calculation for determining the location of the mobile station are used, for example with the TA method, runtime values between mobile station and supplying base station.

### SUMMARY OF THE INVENTION

An object of the invention is to propose an improved method of localizing pocket data service-capable subscriber-side stations in a communication system or a device to perform such a method.

This object is achieved by a method for localizing packet data service-capable subscriber-side stations in a communication system or the communication system with devices for executing such a method.

Through this method the network advantageously does not have to assign any dedicated channels to the mobile station, so that the cell capacity can be preserved. In addition not just individual mobile stations can be interrogated one after the other, but several at the same time.

At least one network-side device, which is preferably a component of the base station system, stores location information about the subscriber stations in its area, so that on request it can immediately supply the position of the mobile station or position-relevant measurement data without having to again establish contact with the corresponding mobile station.

This thus provides a method for GPRS/EGPRS-capable mobile stations in which the base station system is always informed about the location of the mobile stations or the position-relevant measurement data in its cells, so that the base station can respond immediately to an inquiry from higher levels/layers without triggering the desired mobile station. Furthermore the network can, by setting trigger points—for example by definition of a specific local area in their service area—immediately inform subordinate functional units automatically without polling them when a mobile station arrives in this location area, stays there or leaves the area. In this case the SMLC functionality can be integrated into the base station system or be located remotely in a separate device (physical or standalone SMLC). Using the information obtained, such as the location of all subscriber stations, the signal level, the serving cells as well as the adjacent cells and the interference level at the mobile station location, the network can create a complete radio field planning map as well as a highly-accurate distribution map of the mobile stations in the cells. The method makes do without the need for any additional new measurement equipment, i.e. without additional new modules or hardware.

A preferred basis of the method is based on the fact that GPRS/EGPRS-capable mobile stations are in principle permanently registered in the network and are known to the latter (GPRS attached). In this case the network can request the mobile station specifically or via broadcast system information all mobile stations to send messages periodically from which the network determines the position of the mobile station. Thus the network can set trigger points if it knows the position of the mobile station, for which the network, when the subscriber enters/leaves a specific cell area, e.g. a shopping mall, can immediately send information, e.g. advertising, special offers, cinema programs etc. for example using SMS (Short Message Service) to the subscriber station.

The method is advantageously based completely on known signaling of the GSM specifications which can however be utilized very advantageously and in an entirely new combination, e.g. what is known as Network-Controlled Cell Reselection, Network-Controlled Management Reports and Extended Measurement Reports. The method operates both for a mobile station in the idle mode and in the operating mode (idle or packet transfer mode).

The advantage of using GPRS/EGPRS lies in the fact that dedicated channels do not have to be allocated. Instead the mobile stations periodically deliver measurement reports, whereby such reports advantageously always only occupy one 20 ms long radio block or a few radio blocks for longer messages on a packet data channel (PDCH) of the mobile stations are where necessary directed to what are known as shared channels, where they exchange their data in a multiplex procedure with other subscriber stations.

A particular advantage of the method is also that what are known as class-A telephones, or DTM (dual transfer mode) or also simple class-A telephones, in contrast to the current operating procedures (E-OTD, GPS based on circuit switched services), can operate the location service (LCS) without service interrupt, although circuit-switched telephony is also possible simultaneously. This is possible since with simple (Class-A) mobile stations simultaneous operation of voice and data is possible, i.e. the location service can be operated on the packet switched channel while a conversation is taking place on the circuit-switched channel.

The algorithms used in the most simple exemplary embodiment are inherently known procedure elements which are used to determine and notify the interference level in a cell at the location of the mobile station MS, for a cell change or optionally for packet data retrieval requests. These three can however also be used by the described procedure to determine the location.

The procedure can be used on all GPRS/EGPRS-capable mobile stations in the cell. To reduce the load in the network only individual subscribers can be served however. This can also be used to only provide this service for a fee.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 is a schematic overview of a radio communication system

FIGS. 2-4 are Isitings of reports available in the GSM standard for the measurement reports which can be used to execute a method for establishing the location of a GPRS-capable mobile station.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

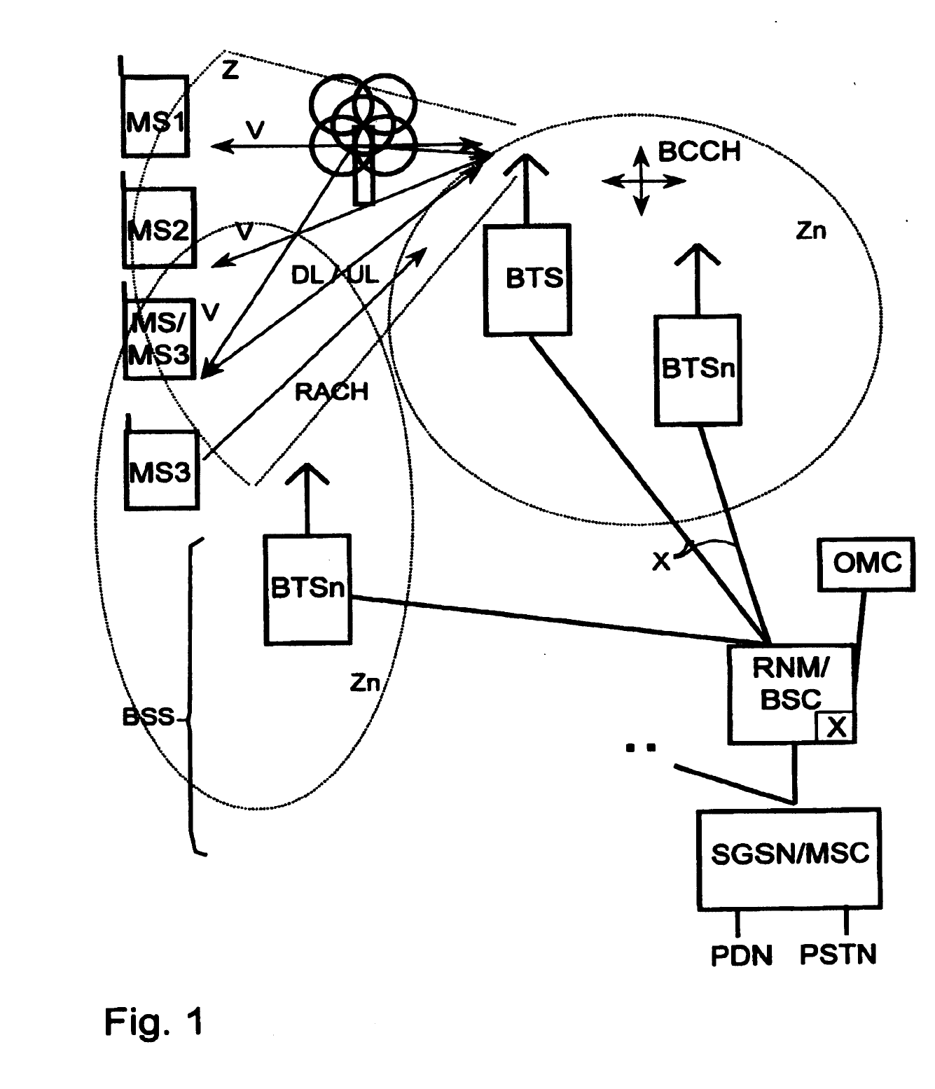

As can be seen from FIG. 1, a mobile radio system as an example of a radio communication system includes a large number of mobile switching centers MSC as well as serving GPRS support nodes (SGSN) which are internetworked or provide access to a public switched telephone network PSTN or a packet data network PDN. Furthermore these mobile switching centers MSC are each connected to at least one base station controller BSC/a device RNM for assigning radio resources. Each of these BSCs in its turn allows a connection to at least one base station BTS. Such a base station BTS can for example establish a connection to subscriber-side or subscriber stations, e.g. mobile stations or other types of mobile and stationary terminals via a radio interface. The base stations and these control units form a base station system (BSS).

At least one radio cell Z is formed by each base station BTS within which communication with mobile stations MS, MS1, . . . is possible. With a sectorization or with hierarchical cell structures a number of radio cells Z are also served by each base station BTS. Typically the areas of adjacent radio cells intersect so that it is no problem to change from the area of one radio cell Z to that of another radio cell Z.

FIG. 1 shows a typical example of existing connections V1, V2, V3 for transmitting payload information and signaling information between mobile subscriber stations MS and a base station BTS and a request for resource allocation or a short confirmation message in a (Packet) Random Access Channel ((P)RACH) through a further Mobile Station MS. Furthermore a Broadcast Control Channel (BCCH) is shown which is provided for transmitting payload and signaling data with a defined transmit power from each of the base stations BTS for all mobile stations MS.

An Operations and Maintenance Center OMC implements control and maintenance functions for the mobile radio system or for parts thereof. The functionality of this structure can be transferred to other radio communication systems, in particular for subscriber access networks with a cordless subscriber interface.

In accordance with a typical, preferred form of embodiment a method can be used for such a system for determining the location of one or more mobile systems for the packet data system GPRS/EGPRS in transfer mode with temporary block flow :TBFs and in idle mode. In the network a data list X is shown for the registered mobile station MS in the area of the base station controller BSC or possibly also in the supporting network nodes for a serving GPRS support node (SGSN) or in the SMLC, in which for the relevant mobile station MS, location, timing advance TA in the relevant cell Z (serving cell), RXLEV (receive level) values and interference values are stored.

Known control reports and control mechanisms can typically be used to control the currently inherently known procedural sequences, (see for example GSM 04.60, GSM 05.06) but are used for completely different purposes.

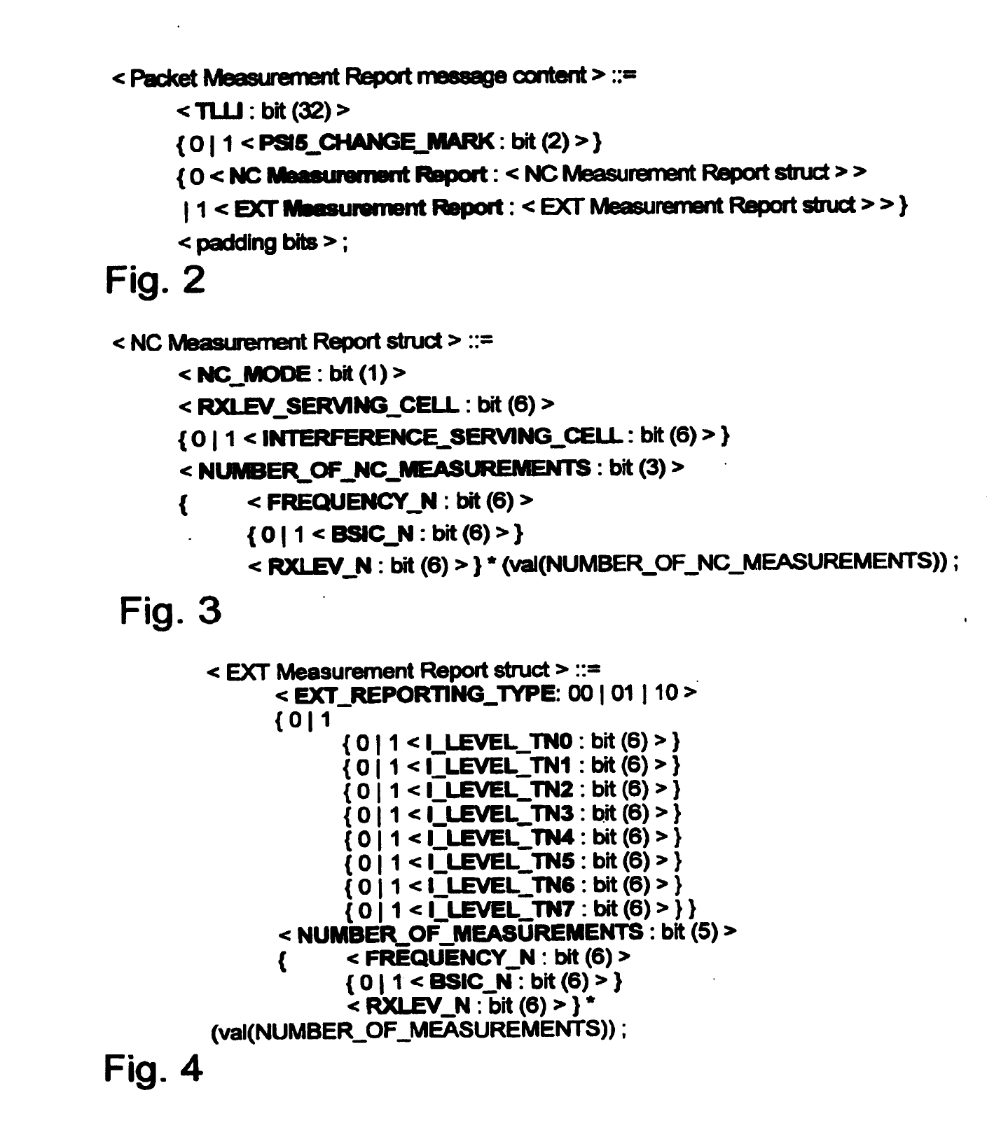

The reports transferred from the mobile stations to the network and their content are outlined in FIGS. 2-4.

Exemplary algorithm execution sequences can be provided especially for registering a packet-data-capable mobile station and the external request can be provided for determining a position.

When a mobile station is registered for GPRS/EGPRS at the network its position should be continually determined and stored, to which end the mobile station is requested to periodically send the measurement reports. The network evaluates these reports as well as the TA measured values and calculates the position of the mobile station MS. Possibly the mobile station will also be shifted by NC Cell Reselection into the neighboring cells.

For servicing incoming external mobile station position requests, this information can, when the position of the mobile station MS is known sufficiently precisely, be directly transferred from the base station system BSS. Otherwise the mobile station MS must be polled to first determine the position or to sufficiently improve the position information.

With GPRS/EGPRS what are known as NC measurement reports from dedicated mobile stations or from all mobile stations MS in cell Z are sent periodically to the network-side equipment if this is requested by the base station BTS via a request sent over a radio or message channel, e.g. the FSI 5 Packet_System_Information_Message (NC CONTROL_ORDER field). The period of such transmissions can with the currently known system be set to between 0.48 and 60.44 by the corresponding radio/broadcast parameters for mobile stations MS in idle mode (NC_Reporting_Period) or for mobile stations MS in transfer mode (NC_Reporting_period_C). The report contains the identifier TLLI (Temporary Logical Link Identifier) of the mobile station as well as the receive level (RXLEV_SERVING CELL) and the interference (INTERFERENCE_SERVING_CELL) in the cell (see FIG. 2, 3) at the position of the mobile station MS. Furthermore the receive level of the neighboring cell is also transmitted (RXLEV_N).

In addition for mobile stations in idle mode what are known as EXTENDED measurement reports can periodically be sent to the network-side equipment (EXT_CONTROL_ORDER). The period here can currently be set between 60 and 7.680 seconds.

This report, in addition to the temporary logical link identifier (TLLI), includes the interference level at the position of the mobile station in all of currently eight time slots (I_LEVEL_TWO . . . 7) as well as the receive level strength value of the neighboring cell (RXLEV_N) at the position of the mobile station.

The neighboring cell list to be measured (ARFCN, BSIC, . . . ) is allocated to the mobile station by the network beforehand (e.g. currently: (BA(GPRS), NC_FREQUENCY_LIST, EXT_FREQUENCY_LIST)),

It can be prespecified on the network side that such measurement reports (NC measurement reports or Extended Measurement Reports) are to be sent periodically to the network only by specific mobile stations MS instead of by all mobile stations in cell Z. For this there is currently the message “Packet_Measurement_Order. A restriction on the transfer of the position information of just individual mobile stations MS is advantageous if for example there are too many mobile stations in a cell so that an overload situation could possibly arise, if not all mobile stations MS are to use the location service (LCS) for example because the subscribers of the corresponding mobile stations MS are not registered for or allowed to use this service.

In addition the period to notify the position-relevant measurement data to the network can be set differently for different mobile stations MS which leads to certain quality differences in accuracy. Thus mobile stations on the move can be instructed to send their position-relevant data more often than mobile stations MS that are not moving at all or are moving only slowly.

The mobile station MS advantageously notifies the network of the measurement data in idle mode by initially executing an access to the network and thereby requesting one or more radio blocks. Using the access burst signal the base station BTS can immediately determine the timing advance (TA) and thereby the gap between the mobile station MS and the base station BTS. With the present procedure this is possible with around 500 m accuracy. By reporting a number of TA values however this figure can be increased.

Using the additional values available of the receive field strength RXLEV of the neighboring cells, generally known electro magnetic propagation laws and the known positions of the base stations BTS of the neighboring cells Zn, the position of the mobile station MS can finally be determined more precisely, but generally still approximately.

If furthermore a map with the network planning data, e.g. previously calculated signal field strengths in the network service area, the location of the mobile station MS can be determined even more exactly by an automatable comparison with the map. An iterative process can be used for this since a highly accurate level/interference map is calculated which can then be used in its turn as input for further calculations.

The linkage of the data with the mobile station MS and its storage in a network-side device such as memory X off the base station controller BSC (or in packet networks what is known as the Serving GPRS Support Node (SGSN) or the SMLC is undertaken preferably using a identifiers such as the already known TLLI (Temporary Logical Link Identifier) which is unique for each mobile station MS and which is contained in the above-mentioned messages.

To further improve the localization the network or its base station controller BSC can shift the mobile stations MS in idle mode currently using for example a network-controlled cell reselection in turn from the cell Z serving the mobile station (serving cell) into the neighboring cells Zn in the receive area of which the mobile station MS is also located. Advantageously the number N of such neighboring cells Zn into which this subscriber station MS can be shifted is at least three (N>=3). The inherently known message “Packet_Cell_Change_Order” can currently be used for this purpose.

Advantageously, the use of services or procedures of the GPRS service in this case requires no interruption of existing services (service interrupt) since in idle mode no data is sent. When the procedure is used for mobile stations MS in the transfer mode data can however be lost which must be transmitted again later or repeatedly.

Advantageously a mobile station MS to be shifted in accordance with the procedure should always be moved into the neighboring cell(s) with the greatest receive field strength (RXLEV). By the movement of the station the network also obtains information about the time advance TA for N neighboring base station BTSs and can now calculate the location more exactly with known methods such as intersection calculation of the N gap circles around the N base stations BTSs. To remain consistent with the data storage and minimize the administration overhead a mobile station MS should preferably always only be moved between the cells of one base station controller BSC area.

Starting with the small resolution of the TA value specified here of around 500 m the resolution can be greatly improved by the network reporting the TA values periodically arriving from the mobile stations MS over time. The same reporting should also be undertaken for the values of the receive field strengths RXLEV of the serving cells and the neighboring cells. A further potential improvement lies in oversampling of the access bursts in the base station BTS or the utilization of further equalizer values.

The network can also accept from mobile stations MS in packet transfer mode the access bursts on the packet timing control channel (PTCCH) in the report which it currently sends every two MS to the network for each mobile station MS. If this information is not sufficient for a mobile station MS as regards accuracy the network can poll the mobile station MS using what is known as the Packet_Polling_Request message for example. In this case the mobile station MS sends four consecutive access bursts in the uplink for Packet_Control_Acknowledgements. Through multiple polling at short intervals the network can create any number of access bursts for highly accurate determination of the time advance TA of a mobile station MS in a cell Z or Zn.

For each cell Z it is likely in the near future that between several hundred and a few thousand mobile stations will be registered in the network. This large number as well as the large amount of data periodically arriving or directly requested by a specific mobile station MS is suitable, averaged over a longer period, for obtaining very good C/I (Carrier to Interference) maps of the network. In addition localization gives the opportunity of observing the distribution of mobile stations MS in the cell Z. Bottlenecks can be avoided in the area of known hot spots by installation of new base stations BTS.

If the report is limited to specific times of day the operator can determine their network coverage in for example the busy hour and at other selected times of the day and night.

This currently gives the operator the opportunity of monitoring or tracing individual mobile stations MS with known Temporary Logical Link Identifiers (TLLI). For specific events and localities, such as for example shopping malls, they can determine precisely which subscribers are entering a particular area or leaving it again. E-mail, Short Message Service (SMS), etc. can be used to offer a service with great potential for advertising etc if the location and data of the mobile stations MS is continuously stored using the procedure in the network-side memory X. As soon as a new memory entry for a specific area is undertaken a corresponding information message can be sent directly or via an advertising center informed about it to the mobile station MS involved.

Advantageously the location service (LCS) data for the mobile station MS can be encrypted to prevent illegal access to these data sequences and data contents (traces) of the mobile station MS.

Using the information obtained such as the current locations of all mobile stations MS in the cells Z, the signal level of these cells serving the mobile stations MS (serving cells) Z as well as the neighboring cells Zn and the interference level at the location of the relevant mobile station, the network can create a complete C/I map as well as a map which specifies the distribution of the mobile stations in the cells Z. This serves to detect hot spots and makes it easier to decide where new base stations must be set up. Furthermore on the basis of the maps the current network planning can be checked and existing planning resources adapted. The map can again be introduced into the location service process in order to obtain an adaptive procedure in which a self-learning/optimizing network can be constructed. Such maps can especially be set up for different times of the day, e.g. busy hour, night time.

The use the inherently-known GPRS procedure offers a clever linkage of existing GSM signaling to collect the information needed. Operated without additional overhead, in contrast to the current method the location of the mobile station MS is permanently determined.

In particular there is the option of setting trigger points so that mobile stations MS which are located in a specific area, e.g. a shopping mall, can be supplied immediately via SMS e-mail or other methods e.g. promotion, special offers etc.

The use of the procedure is particularly advantageous for Class A or simple class A mobile stations, since with the existing voice connections no service interrupt is necessary.

All mobile stations MS in the cells or only mobile stations registered for the location service LCS can be supplied with the location service LCS or with services building on LCS. The accuracy of the measurements can also be determined MS-specifically, e.g. by individual setting of the measurement report periods and/or additional polling of the mobile station MS to initiate access bursts for local or time advance (TA) determination. Of advantage is a greater periodicity at busy hour to claim as little network capacity of possible and very small periodicities during the night when the network load is relatively small.

The known “NC Cell Reselection” can be used for mobile stations MS in idle or transfer mode in order to obtain the values from the cell Z serving the mobile station as well as the adjacent neighboring cells. Reports are produced for time advance TA, receive level RXLEV etc. in order to achieve greater accuracy in calculations.

Packet_Polling_Requests also allow any number of access bursts to be generated by a mobile station MS in order to obtain a more accurate TA. Encryption of the data in the network prevents illegal access.

When each measurement report is transferred the mobile station uses access bursts to access the RACH/PRACH (Random Access Channel or Packet Random Access Channel) with which the network measures the TA value and stores the TA value and other position-relevant measurement data of the cell and the neighboring cells under the identifier of the mobile station. The accuracy of the TA value is increased here by averaging it over a number of accesses. If this accuracy of the TA value in a cell is not sufficient the network should establish a data connection on a packet channel (PDCH: Packet Data Channel). In this case the mobile station is requested once or a number of times in succession, using access bursts, to send what are known as Packet Control Acknowledgements on this packet data channel. This is for example achieved by the currently known message “Packet Polling Request”, If the position of the subscriber is not sufficiently accurate the network can divert the mobile station using what is known as Network Controlled Cell Reselection (Packet Cell Change Order) into selected adjacent cells. The measurements and TA values made there are also stored under the identification of the mobile station.

If a mobile station is in what is known as packet transfer mode, i.e. a packet connection is activated, the network additionally evaluates the TA values which are currently transferred to it every 2 seconds via the Packet Timing Control Channel (PTCCH) for continuous TA setting.

The invention has been described in detail with particular reference to preferred embodiments thereof and examples, but it will be understood that variations and modifications can be effected within the spirit and scope of the invention.

1-11. (cancelled)

12. A method for operating a radio communication system with packet data-capable mobile stations in which each mobile station communicates with an assigned base station via at least one radio interface within a radio cell in a network to identify locations of the mobile stations, comprising:
registering at least one mobile station in the network;
receiving a request from the network at the base station to periodically send reports from which the location of each mobile station can be determined; and
recording in the network at least one of a current location of the at least one mobile station and measurement data recorded to determine the current location of the at least one mobile station and the assigned base station.

13. A method in accordance with claim 12, further comprising determining the location of the at least one mobile station regardless of whether the at least one mobile station has a dedicated connection to the network.

14. A method in accordance with claim 13, wherein said determining includes performing at least once a procedure for changing a cell independently of whether the one of the mobile stations is actively in transmission mode or passively in idle mode.

15. A method in accordance with claim 13,
wherein said recording includes storing at least one of receive level, interference level and timing advance of the at least one mobile station, and
further comprising averaging over time the at least one of receive level, interference level and timing advance of the at least one mobile station to improve accuracy thereof.

16. A method in accordance with claim 13, wherein said determining includes performing at least once a procedure to activate the at least one mobile station by a polling request.

17. A method in accordance with claim 13, wherein said determining includes directly supplying network devices with the at least one of a current location of the at least one mobile station and measurement data stored on the network in response to a request to determine the location of the at least one mobile station.

18. A method in accordance with claim 13, further comprising accessing the at least one mobile station in a packet data service mode to determine the location of a network device.

19. A method in accordance with claim 13, further comprising creating maps to show at least one of signal field strength, interference level and network utilization based on the measurement data.

20. A method in accordance with claim 13, further comprising automatically sending from the network messages to the at least one mobile station based on stored location values if predefined trigger points are fulfilled.

21. A radio communication system with packet data service-capable mobile stations in which at least one mobile station communicates with an assigned base station via at least one radio interface within a radio cell in a network to identify locations of the mobile stations, comprising:
at least one base station, coupled to the network, to operate at least one radio cell within which the at least one mobile station communicates if required with the base station via a radio interface;
at least one network device, coupled to the network, to instruct the base station to execute on request a localization process to determine the location of the at least one mobile station; and
at least one memory device, coupled to the network, to store at least one of a current location of the at least one mobile station, receive level, interference level and timing advance of the at least one mobile station for localization thereof.

22. A storage in a communication system with packet data service-capable mobile stations in which at least one mobile station communicates with an assigned base station via at least one radio interface within a radio cell in a network to identify locations of the mobile stations, comprising:
at least one memory device, coupled to the network, to store at least one of a current location of the at least one mobile station, receive level, interference level and timing advance of the at least one mobile station for localization thereof in response to a request to determine the location of the at least one mobile station.
